(19) United States
(12) Patent Application Publication
(10) Pub. No.: US 2002/0196275 A1
(43) Pub. Date: Dec. 26, 2002

(54) Method and apparatus for facilitating display of an advertisement with software

(76) Inventors: Barry E. Willner, Briarcliff Manor, NY (US); David P. Greene, Ossining, NY (US); Edith H. Stern, Yorktown Heights, NY (US); Philip Shi-Iung Yu, Chappaqua, NY (US)

Correspondence Address: BUCKLEY, MASCHOFF, TALWALKAR, & ALLISON, 5 ELM STREET, NEW CANAAN, CT, 06840, US

(21) Appl. No.: 09/887,817

(22) Filed: Jun. 22, 2001

(51) Int. Cl. G09G 5/00

(52) U.S. Cl. 345/744

(57) ABSTRACT

A system, method, apparatus, and computer program code for facilitating the display of an advertisement with software. According to embodiments of the present invention, a method includes determining a portion of software; determining an advertisement; and establishing a relationship between said portion of software and said advertisement such that an interruption of use of said portion of software on a device can occur, said interruption of use associated with at least one display of said advertisement by said device. In some embodiments, a benefit may be associated with the advertisement that is based, at least in part, on display of the advertisement.

### CROSS-REFERENCE TO RELATED PATENT APPLICATION

This patent application is related to co-pending patent application entitled Method and Apparatus for Facilitating the Providing of Content, which has application serial No. ______ and was filed on Jun. 22, 2001, all of which is incorporated herein by reference.

### FIELD OF THE INVENTION

The present invention relates to a method and apparatus for associating content with software and, more particularly, embodiments of the present invention relate to methods, apparatus, and computer program code for providing an advertising option with software.

### BACKGROUND OF THE INVENTION

There are many options available for an advertiser to provide and promote advertisements. Included among these options is the display of advertisements on or in electronic forums such as World Wide Web (“Web”) sites, bulletin boards, email message campaigns, etc. In the past, companies have allowed customers to download a program that provides advertisements to the customers as the customers surf the Web. In addition, other companies such as Vindigo (www.vindigo.com) provide software for personal digital assistants that display advertisements.

Unfortunately, these prior art systems do not associate display of an advertisement with a benefit or attribute related to the software. In addition, these prior art systems enable the software to maintain operation while advertisements are being displayed, thereby muting the impact and value of the advertisements.

It would be advantageous to provide a method and apparatus that overcame the drawbacks of the prior art. In particular, it would be desirable to provide a method and apparatus for integrating or otherwise bundling one or more advertisements with software such that display of an advertisement by a device may delay, suspend or otherwise interrupt operation of the device or the software and/or such that a benefit related to the software is at least partially dependent on the display of one or more advertisements by the device.

### SUMMARY OF THE INVENTION

Embodiments of the present invention provide a system, method, apparatus, and computer program code for facilitating display of an advertisement by a device in conjunction with use or operation of software on the device. According to embodiments of the present invention, software and one or more advertisements may be associated or otherwise bundled together such that an advertisement may be displayed by a device when the software is operating on the device and such that operation of the device, software on the device, or an attribute of the software or device is interrupted when the advertisement is displayed by the device. In other embodiments, an attribute of the software may be dependent, at least in part, on the display of an advertisement. For example, in some embodiments a feature of a software product may not be accessible on or usable with a device unless an advertisement has previously been displayed by the device or is currently being displayed by the device. In other embodiments, the price of the software may be decreased each time the advertisement is displayed by the device.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating display of an advertisement with a portion of software includes determining a portion of software; determining an advertisement; and establishing a relationship between the portion of software and the advertisement such that an interruption of use of the portion of software on a device can occur, the interruption of use associated with at least one display of the advertisement by the device. In another embodiment, a method for facilitating display of an advertisement with a portion of software includes bundling a portion of software and an advertisement such that an interruption of use of the portion of software may occur during at least a portion of at least one display of the advertisement; and providing a notification of a benefit associated with the bundled arrangement of the portion of software and the advertisement. In a further embodiment, a method for facilitating display of an advertisement with a portion of software includes determining a first advertising unit available with a portion of executable software, wherein operation of the portion of software is interruptible by a display of an advertisement; and determining a first advertisement to fill the first advertising unit. In another embodiment, a method for facilitating display of an advertisement with a portion of executable software includes determining a plurality of advertising units available with a portion of executable software, wherein operation of the portion of executable software is interruptible by a display of an advertisement; determining an first advertisement to fill a first of the plurality of advertising units and a second advertisement to fill a second of the plurality of advertising units; and bundling the portion of executable software, the first advertisement and the second advertisement. In a further embodiment, a method for facilitating display of an advertisement with a portion of executable software includes bundling a portion of software and at least one advertisement such that an attribute of the portion of software is at least partially dependent on display of the at least one advertisement on a device; and providing a notification of the attribute. In another embodiment, a method for providing a benefit for display of an advertisement associated with a portion of software includes identifying a bundling of a portion of software and an advertisement such that the advertisement may be displayed by a device when the portion of software is operated with the device; determining a benefit associated with at least one display of the advertisement; and providing a notification of the benefit. In a further embodiment, a method for using an advertisement with a portion of software includes receiving a portion of software; receiving an advertisement, the advertisement being associated with the software such that operation of the portion of executable software on a device can be interrupted during at least a portion of at least one display of the advertisement by the device; and operating the portion of software.

According to one embodiment of the present invention, a system for facilitating display of an advertisement includes a memory; a communication port; and a processor connected to the memory and the communication port, the processor being operative to determine a portion of software; determine an advertisement; and establish a relationship between the portion of software and the advertisement such that an interruption of use of the portion of software on a device can occur, the interruption of use associated with at least one display of the advertisement by the device. In another embodiment, the processor may be operative to bundle a portion of software and an advertisement such that an interruption of use of the portion of software may occur during at least a portion of at least one display of the advertisement; and provide a notification of a benefit associated with the bundled arrangement of the portion of software and the advertisement. In a further embodiment, the processor may be operative to determine a first advertising unit available with a portion of executable software, wherein operation of the portion of software is interruptible by a display of an advertisement; and determine a first advertisement to fill the first advertising unit. In another embodiment, the processor may be operative to determine a plurality of advertising units available with a portion of executable software, wherein operation of the portion of executable software is interruptible by a display of an advertisement; determine an first advertisement to fill a first of the plurality of advertising units and a second advertisement to fill a second of the plurality of advertising units; and bundle the portion of executable software, the first advertisement and the second advertisement. In a further embodiment, the processor may be operative to bundle a portion of software and at least one advertisement such that an attribute of the portion of software is at least partially dependent on display of the at least one advertisement on a device; and provide a notification of the attribute. In another embodiment, the processor may be operative to identify a bundling of a portion of software and an advertisement such that the advertisement may be displayed by a device when the portion of software is operated with the device; determine a benefit associated with at least one display of the advertisement; and provide a notification of the benefit. In a further embodiment, the processor may be operative to receive a portion of software; receiving an advertisement, the advertisement being associated with the software such that operation of the portion of executable software on a device can be interrupted during at least a portion of at least one display of the advertisement by the device; and operate the portion of software.

According to one embodiment of the present invention, an apparatus for facilitating display of an advertisement may include means for selecting a portion of software; second instructions for selecting an advertisement; and means for creating an interruption of use of the portion of software on a device, the interruption of use associated with at least one display of the advertisement by the device. In another embodiment, an apparatus for facilitating display of an advertisement with a portion of software includes means for associating a portion of software and an advertisement such that an interruption of use of the portion of software may occur during at least a portion of at least one display of the advertisement; and means for sending a notification of a benefit associated with the bundled arrangement of the portion of software and the advertisement. In a further embodiment, an apparatus for facilitating display of an advertisement with a portion of software includes means for selecting a first advertising unit available with a portion of executable software, wherein operation of the portion of software is interruptible by a display of an advertisement; and means for selecting a first advertisement to fill the first advertising unit. In another embodiment, an apparatus for facilitating display of an advertisement with a portion of executable software includes means for selecting a plurality of advertising units available with a portion of executable software, wherein operation of the portion of executable software is interruptible by a display of an advertisement; means for selecting a first advertisement to fill a first of the plurality of advertising units and a second advertisement to fill a second of the plurality of advertising units; and means for associating the portion of executable software, the first advertisement and the second advertisement. In a further embodiment, an apparatus for facilitating display of an advertisement with a portion of executable software includes means for associating a portion of software and at least one advertisement such that an attribute of the portion of software is at least partially dependent on display of the at least one advertisement on a device; and means for sending a notification of the attribute. In another embodiment, an apparatus for providing a benefit for display of an advertisement associated with a portion of software includes means for selecting a bundling of a portion of software and an advertisement such that the advertisement may be displayed by a device when the portion of software is operated with the device; means for selecting a benefit associated with at least one display of the advertisement; and means for sending a notification of the benefit. In a further embodiment, an apparatus for using an advertisement with a portion of software includes means for obtaining a portion of software; means for obtaining for obtaining an advertisement, the advertisement being associated with the software such that operation of the portion of executable software on a device can be interrupted during at least a portion of at least one display of the advertisement by the device; and means for implementing the portion of software.

According to one embodiment of the present invention, a computer program product in a computer readable medium for facilitating display of an advertisement may include first instructions for identifying a portion of software; second instructions for identifying an advertisement; and third instructions for causing an interruption of use of the portion of software on a device, the interruption of use associated with at least one display of the advertisement by the device. In another embodiment, a computer program product in a computer readable medium for facilitating display of an advertisement with a portion of software includes first instructions for bundling a portion of software and an advertisement such that an interruption of use of the portion of software may occur during at least a portion of at least one display of the advertisement; and second instructions for providing a notification of a benefit associated with the bundled arrangement of the portion of software and the advertisement. In a further embodiment, a computer program product in a computer readable medium for facilitating display of an advertisement with a portion of software includes first instructions for determining a first advertising unit available with a portion of executable software, wherein operation of the portion of software is interruptible by a display of an advertisement; and second instructions for determining a first advertisement to fill the first advertising unit. In another embodiment, a computer program product in a computer readable medium for facilitating display of an advertisement with a portion of executable software includes first instructions for determining a plurality of advertising units available with a portion of executable software, wherein operation of the portion of executable software is interruptible by a display of an advertisement; second instructions for determining an first advertisement to fill a first of the plurality of advertising units and a second advertisement to fill a second of the plurality of advertising units; and third instructions for bundling the portion of executable software, the first advertisement and the second advertisement. In a further embodiment, a computer program product in a computer readable medium for facilitating display of an advertisement with a portion of executable software includes first instructions for bundling a portion of software and at least one advertisement such that an attribute of the portion of software is at least partially dependent on display of the at least one advertisement on a device; and second instructions for providing a notification of the attribute. In another embodiment, a computer program product in a computer readable medium for providing a benefit for display of an advertisement associated with a portion of software includes first instructions for identifying a bundling of a portion of software and an advertisement such that the advertisement may be displayed by a device when the portion of software is operated with the device; second instructions for determining a benefit associated with at least one display of the advertisement; and third instructions for providing a notification of the benefit. In a further embodiment, a computer program product in a computer readable medium for using an advertisement with a portion of software includes first instructions for receiving a portion of software; second instructions for receiving an advertisement, the advertisement being associated with the software such that operation of the portion of executable software on a device can be interrupted during at least a portion of at least one display of the advertisement by the device; and third instructions for operating the portion of software. In another embodiment, a software program may include a portion of executable software and at least one advertisement, wherein operation of the portion of executable software on a device can be interrupted during at least a portion of at least one display of the at least one advertisement by the device. In Another embodiment, a software program include a portion of executable software and at least on advertisement, wherein performance of the portion of executable software on a device can be altered as a result of at least one display of the at least one advertisement by the device.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is an illustration of an advertisement displayed by a computer in accordance with the method of FIG. 1;

FIG. 3 is an illustration of an advertisement displayed by a personal digital assistant in accordance with the method of FIG. 1;

FIG. 4 is a flowchart of a second embodiment of a method in accordance with the present invention;

FIG. 5 is a flowchart of a third embodiment of a method in accordance with the present invention;

FIG. 6 is a flowchart of a fourth embodiment of a method in accordance with the present invention;

FIG. 7 is a block diagram of system components for an embodiment of an apparatus usable with the methods of FIGS. 1 and 4-6;

FIG. 8 is a block diagram of components of one embodiment of a server of FIG. 7;

FIG. 9 is an illustration of one potential implementation of the user information database of FIG. 8;

FIG. 10 is an illustration of one potential implementation of the user device information database of FIG. 8;

FIG. 11 is an illustration of one potential implementation of the advertisement information database of FIG. 8;

FIG. 12 is an illustration of one potential implementation of the advertiser information database of FIG. 8; and

FIG. 13 is an illustration of one potential implementation of the software information database of FIG. 8.

### DETAILED DESCRIPTION

Applicants have recognized that there is a need for systems and methods that facilitate or otherwise allow an advertisement or other content to be displayed by a device in conjunction with the operation of software on or with the device. A display of an advertisement by a device may include an audio component and/or a visual component. Thus, in some embodiments, a device may display an advertisement by visually displaying the advertisement on a screen. In other embodiments, a device may display an advertisement by playing a music, voice or other sound segment or file.

An advertisement may include text, rich media, animations, graphics, audio or sound, etc. The software may be or include any type of computer program, software instructions, code, etc. In some embodiments, an advertisement may be associated or related to a portion of software such that the advertisement may be displayed by a device when the software is operating on the device and such that a display of the advertisement by the device may interrupt operation of the software.

Interruption of the software may include disabling or preventing use of a feature of the software while the advertisement is being displayed, slowing down or suspending performance or operation of the software while the advertisement is being displayed, preventing a device displaying an advertisement from storing, receiving, transmitting files or other data during display of the advertisement, etc. In some embodiments, a user of the software may determine or select when and how an advertisement is to be displayed by a device. In other embodiments, a rule, procedure, function, process or algorithm may determine when an advertisement is to be displayed by a device, how long the advertisement is to be displayed, how many times the advertisement can or will be displayed, what interruption of the device or portion of software occurs when the advertisement is displayed, etc. These and other features will be discussed in further detail below, by describing a system, individual devices, and processes according to embodiments of the invention.

Process Description

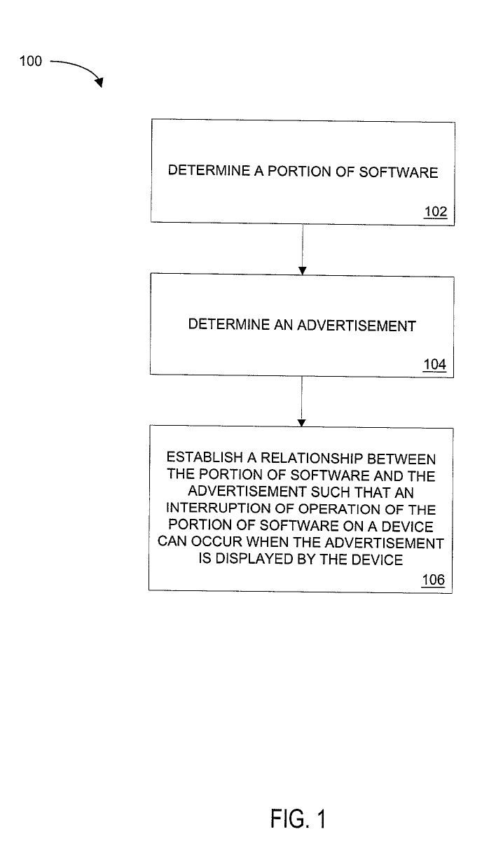

Reference is now made to FIG. 1, where a flow chart 100 is shown which represents the operation of an embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below. The method 100 may be used to associate or otherwise bundle one or more advertisements with a software program or group of software programs such that one or more of the advertisements may be displayed when one or more of the software programs is being used or operated. In some embodiments, an advertisement may be associated with more than one software program, and vice versa.

Processing begins at a step 102 during which a portion of software is determined. The software may be or include an operating system, software application (e.g., word processing program, spreadsheet program, browser), software tool, Java script, applet, or any other type of code, computer program, or list or set of computer instructions. In some embodiments, the software may be in executable format. In some embodiments, a device or entity implementing the method 100 or the step 102 may determine the portion of software during the step 102 by receiving or retrieving the portion of software from another device or entity, a database, etc. For example, a device implementing the method 100 may receive the portion of software from a software developer that wants to incorporate one or more advertisements into the software or otherwise associate one or more advertisements with the portion of software. In some embodiments, a device or entity implementing the method 100 or the step 102 may receive data (e.g., a link, URL, electronic address, database location) indicative of a location of the portion of software prior to retrieving, downloading or receiving the software. Information regarding one or more portions of software may be stored in or accessed from a software information database. In some embodiments of the method 100 and the other methods disclosed here, the portion of software determined during the step 102 may be limited to executable software.

In some embodiments, a device or entity implementing the method 100 or the step 102 may select or otherwise identify the portion of software from a plurality of portions of software. For example, a software producer or developer that wishes to include one or more advertisements may select one or more programs based on release dates of the programs, the demographic profiles of anticipated customers or users of the software, the requirements or desires of an advertiser supplying the advertisements, the number or nature of available advertisements, etc. As another example, a user purchasing software may select or indicate the software as part of the step 102 or the method 100.

In some embodiments information regarding one or more users may be stored in, or accessed from, a user information database. Similarly, in some embodiments information regarding one or more devices may be stored in, or accessed from, a device information database. Likewise, in some embodiments information regarding one or more software providers or products may be stored in, or accessed from, a software information database.

During a step 104, one or more advertisements are identified or otherwise determined. A device or entity implementing the method 100 or the step 104 may receive one or more advertisements from another device (e.g., an ad server) or entity (e.g., an advertiser) or retrieve one or more advertisements from another device or entity. In some embodiments, an entity or device may select an advertisement from a group or set of available advertisements based on the software identified during the step 102, the target audience for the software (i.e., an advertisement is selected that matches the demographic profile of the target audience of the software), advertiser requirements, etc. As another example, a user purchasing software may select or indicate one or more advertisements as part of the step 104 or the method 100. In some embodiments, a device or entity implementing the method 100 or the step 104 may receive data indicative (e.g., a link, URL) of a location of the advertisement prior to retrieving, downloading or receiving the advertisement. Information regarding one or more advertisements may be stored in or accessed from an advertisement information database. Information regarding one or more advertisers may be stored in or accessed from the same database or an advertiser information database.

The step 104 may be initiated or completed prior to or simultaneously with the step 102. In some embodiments, the step 104 may be completed as part of the step 102, or vice versa.

An advertisement may be or include many things such as, for example, one or more images or graphics, text material, software code, one or more animations, rich media, audio and/or video material, a sound file, a multimedia file, an electronic signal, etc. The advertisement determined during the step 104 may or may not be thematically related to the portion of software determined during the step 102.

During a step 106, a relationship is established between the portion of software identified during the step 102 and the advertisement identified during the step 104 such that the advertisement can be displayed by a device (e.g., a computer, personal digital assistant, cellular telephone, pager) when the portion of software is operating on the device and/or such that operation, use, display, etc of the portion of software or the device will be at least partially or temporarily interrupted during display of the advertisement by the device. Thus, the software is bundled with the advertisement. For example, during display of an advertisement by a device, use or other operation of a word processing, spreadsheet, billing or other software program operating may be temporarily suspended on the device until the advertisement is no longer displayed by the device. As another example, during display of an advertisement by a device, display of images, graphics, etc. generated by operation of a word processing, spreadsheet, billing or other software program operating may be temporarily suspended such that nothing is displayed by the device other than the advertisement. In some embodiments, a relationship between the portion of software determined during the step 102 and multiple advertisements (including the advertisement determined during the step 104) may be established during the step 106. In some embodiments, an interruption may be or include display or “popping up” of a window, graphic, frame, etc. that contains or includes an advertisement, which may be temporary or permanent or last until a user responds to the advertisement (e.g., by clicking on the advertisement) in some predefined manner. An interruption may be or include delays, preventions or other delays in calls made by software and/or a device regarding an operating system, delays or other interruptions in screen displays, etc.

In some embodiments, an interruption may include one or more of the following: an interruption in display of material by a device or a portion of software operating on the device; a delay in use or manipulation of data by a device or a portion of software operating on the device; a display of a window by a device or a portion of software operating on the device, a change in display of material by a device or software operating on the device from foreground to background or from background to foreground, etc.

In some embodiments, an interruption may cause or generate a display of a window, frame, image, graphic, etc. by a device or software operating on the device.

An interruption of use of a portion of software may occur in a variety of ways. For purposes of explanation of the present invention and the claims that follow, the phrases “interruption of use” and “interruption of operation” will be used interchangeably. In some embodiments, an interruption of a portion of software may include one or more of the following: a delay in operation of the portion of software on a device while an advertisement is being displayed by the device; a temporary prevention or delay of use of at least one feature of the portion of software while an advertisement is being displayed by the device; a suspension or delay of usability of the portion of software while an advertisement is being displayed by the device; a delay in visual display of data by the portion of software or the device; a delay in transmission, storage or reception of data by the device and/or the portion of software; etc. Thus, display of an advertisement by a device may suspend operation of a portion of software or the device while the advertisement is displayed by the device.

There are at least three different ways that one or more advertisements might be integrated, incorporated or otherwise bundled with a portion of software such that a relationship is formed. First, the advertisement (or one or more links to the advertisement, one or more advertisement or banner calls, one or more call returns, etc.) might be inserted or otherwise included in the code, instructions, programming, etc. for the portion of software such that the advertisement (or one or more links to the advertisement) forms part of the portion of software or data, files, etc. associated or used with the portion of software. Thus, while the advertisement is being displayed by a device, the remaining portion of software may be limited in operation, display, use, accessibility, etc. via the device.

As a second possible implementation, a relationship or bundling may be established between two separate software programs, a first software program that is or includes the portion of software and a second software program that includes the advertisement (or one or more links to the advertisement) and at least partially governs or controls display of the advertisement and the operation of the portion of software. For example, the second program may be able to suspend or otherwise interrupt operation and/or use of the first program while the advertisement is being displayed. The first program already may be resident and operating on the device prior to the second program being stored on or operated with the device. Thus, the second software program may be supplied or used independently of the first software program.

As a third possible implementation, a software program that includes an advertisement (or one or more links to the advertisement) may be able to override an operating system, registry, etc. operating on a device such that the advertisement can be displayed by the device and such that operation, display, use, etc. of one or more other portions of software operating on the device can be suspended, delayed, or otherwise interrupted. Thus, a relationship is established between the advertisement and a portion of software operating on the device, even though the portion of software may change and selection of the portion of software may be controlled by a user of the device. Screen displays, calls to and/or from an operating system made by the software, etc. may be delayed or prevented as part of an interruption.

As mentioned above, in some embodiments, links, Uniform Resource Locators (URLs), or other data indicative of a location of the advertisement may be inserted or included in, or otherwise associated with, the portion of software instead of the advertisement itself. This allows an indirect relationship to be established between an advertisement and the portion of software. When a call or request is made by a device to or using the link, URL or other data, the advertisement may be retrieved or accessed for display by the device.

Selection of the advertisement may be made in advance, may change over time, by advertiser, by system under control of an advertiser, or by user. For example, the step 106 may include inserting a link to an advertisement server and other code into a portion of software. When a call or request for the advertisement is made by a device to the advertisement server using the link, the advertisement server may select an advertisement to serve or download to the device. The call or request may include user or user device information, an advertisement identifier, a user identifier, etc. The advertisement server may select the advertisement based on demographic information associated with a user of the device, the location of the device, the occurrence of an external event (e.g., holiday), the desires of an advertiser, the availability of an advertisement, etc. The advertisement server may update or change advertisements over time as advertisements expire, are updated or replaced, etc. Thus, multiple uses of the same link by a device or software operating on the device may result in different advertisements being retrieved, accessed or displayed by the device.

In some embodiments, the device, user, or advertisement server may request or select an advertisement based on the communication channel (e.g., telephone line, Internet or other computer network) established between the advertisement server and the device. For example, if the communication channel between the advertisement server and the device is a low bandwidth or slow communication network or line, the advertisement may include only text information or simple graphics to allow the advertisement to be transmitted quickly. Alternatively, if the communication channel between the advertisement server and the device is a high bandwidth or fast communication network or line, the advertisement may include animations, complex graphics, rich media, music or other sound files, etc. Thus, in some embodiments, the portion of software, device, or advertisement server, user or some other device or party may monitor, determine or select the communication channel capacity or capabilities between the device and the advertisement server.

As illustrated by the examples above, establishing a relationship between the portion of software determined during the step 102 and the advertisement determined during the step 104, or otherwise bundling the portion of software and the advertisement, may include one or more of the following: providing the portion of software and the advertisement to a device or a user; providing the portion of software and a link to the advertisement to a device or a user; storing the advertisement and the portion of software on a computer readable medium (e.g., floppy disk, CD-ROM); etc.

In some embodiments the step 106 or the method 100 may include one or more of the following: determining when, under what circumstances and/or how an advertisement will or can be displayed by a device or to a user; determining a length of time an advertisement will or can be displayed by a device or to a user; providing a notification of the relationship between a portion of software and an advertisement; etc.

In some embodiments, a display of an advertisement on a device may last for a limited period of time. The length of time may be based, in whole or in part, on may things such as, for example: the number of times one or more advertisements has been displayed by the device, the rate of display of one or more advertisements by the device, demographic information of a user associated with the device, storage or other technical capabilities or operational features of the device, the type or nature of the portion of software, etc. In some embodiments, a relationship or other bundling may be established between a portion of software and an advertisement such that the advertisement will be displayed a minimum, maximum, finite, or random number of times by a device in conjunction with the portion of software. In other examples, an advertisement may be displayed by a device at regular time intervals or at random, at the request of a user of the device, at the request of an advertiser, at the request of a system or the device, as or as part of a screen saver for the device, at a regular interval or random number of keystrokes or data entries made by a user, every time a user uses or accesses a specific feature of the device or the portion of software associated or bundled with the advertisement, the occurrence of an external event (e.g., Thanksgiving, a sale at a particular store, a restaurant opening, an overstock or oversupply of a product), etc. As another example, display of an advertisement by a device may be governed in whole or in part by a usage pattern of a user. More specifically, the advertisement may be displayed by a device every time the user hits or enters a specific set of keys, commands or data, every time the device or portion of software is idle or unused for a minimum period of time, every time the user hits a key or makes an entry after the device or portion of software has been idle or unused for a minimum period of time, etc.

In some embodiments, one or more rules, procedures, algorithms, functions, heuristics, routines, expert systems, learning systems, conventions, policies, etc. may be determined, selected, received or otherwise established to govern how, how long, when, under what circumstances, etc. an advertisement may be used with or displayed by a device and/or a portion of software.

In some embodiments, a server, user device or other device may determine a number of times one or more advertisements has been or will be displayed by a device in conjunction with a portion of software operating on a device, a length of time one or more advertisements has been or will be displayed by a device in conjunction with a portion of software operating on a device, receive feedback from a user viewing an advertisement or using the software, etc.

In some embodiments, the method 100 may include a step of providing the portion of software determined during the step 102. Providing a portion of software may include one or more of the following: providing, serving, downloading, etc. the portion of software to a user device, server or other device; including the portion of software in an electronic communication (e.g., email message, cellular telephone call, instant message communication, XML feed, HTTP, FTP or HTML transmission); providing an electronic address or other data indicative of where the portion of software can be found, requested, operated, accessed and/or retrieved; etc.

In some embodiments, the method 100 may include a step of providing the advertisement determined during the step 104. Providing an advertisement may include one or more of the following: providing, serving, downloading, etc. the advertisement to a user device, server or other device; including the advertisement in an electronic communication (e.g., email message, cellular telephone call, instant message communication, XML feed, HTTP, FTP or HTML transmission); providing an electronic address or other data indicative of where the advertisement can be found, requested, operated, accessed and/or retrieved; etc.

In some embodiments, the method 100 may include a step of determining a benefit available as a result of a display of an advertisement by a device and/or a viewing of the advertisement by a user. For example, a purchaser of an accounting software program (i.e., a portion of software) may receive a retroactively applied rebate on the price of the software program as a result of viewing one or more advertisements displayed by a computer when the purchaser is operating or using the software program with the computer. As another example, the user may receive frequent flyer miles for each advertisement viewed by the user or displayed on a device associated with the user. As another example, speed or performance of a portion of software on a device may be increased as a user views one or more advertisements associated with portion of software or the advertisements or displayed by the device and/or decreased as the rate of display of advertisements by the device decreases. As still another example, availability of features (e.g., the ability to print, transmit, receive or store files or documents) of the portion of software may be increased as advertisements are displayed by the device.

A benefit may be or include many things such as, for example, an improvement in performance of a portion of software or a device; an availability of a feature provided by a portion of software or a device; a rebate for a previous purchase of a portion of software or a device; a discount for a future purchase of a portion of software or a device; a credit; cash or other monetary amount; a coupon; frequent flyer miles; long distance calling time; etc.

In some embodiments, a benefit may be based one or more of the following: feedback from a user regarding an advertisement, a device, or a portion or software; a time of day; a month or season of year; a day of week; a number of updates to a portion of software and/or an advertisement requested by or provided to a user; a demographic or biometric characteristic or measurement of a user; a previous user reaction to an advertisement; amount or quality of feedback or other information provided by a user; one or more previous advertisements viewed; a number of advertisements displayed by a device during a time period; an action taken by a user in response to an advertisement; a monetary amount or rate associated with an advertisement; a status or social index associated with a user; a price associated with a portion of software; a number of displays of an advertisement on a device; a length of time an advertisement is displayed by a device; a number of times a portion of software is operated with a device; a length of time a portion of software is operated with a device; etc.

Obtaining feedback from a user may be conducted actively by asking the user one or more questions, which may be included as part of an advertisement or follow the display of an advertisement. Alternatively, feedback may be obtained from a user passively by monitoring the user's actions (e.g., mouse movements, keyboard strokes, head motion, body heat). Thus, one or more of the methods disclosed herein may include monitoring or determining viewing behavior by a user. An evaluation of viewing behavior may be based, at least in part, on the user's duration of exposure to an advertisement, the number of times a user is exposed to an advertisement, biometric information from the user, the user's responses to an advertisement, the size or exposure duration of an advertisement, etc.

In some embodiments, determining a benefit available for or associated with display of an advertisement may include one or more of the following: receiving a notification of the benefit; allowing a user to select from a plurality of benefits; offering a choice or plurality of benefits to a user and receiving a notification from the user of a selection of at least one of the benefits; receiving a request from a user for a benefit; and/or selecting the benefit from a group of currently available of benefits.

In some embodiments, the method 100 may include providing a notification of a benefit. Providing a notification of the benefit may include one or more of the following: providing the notification to a user, a device, a provider or receiver of the benefit, a provider or user of the advertisement or portion of software, etc.; and/or sending an electronic communication to an address associated with a user, a device, a provider or receiver of the benefit, a provider or user of the advertisement or portion of software, etc. A notification may be in any format or form, including, but not limited to, HTTP, HTML or FTP transmission, XML feed, email message, instant message communication, facsimile or radio transmission, telephone call, electronic signal or communication, etc.

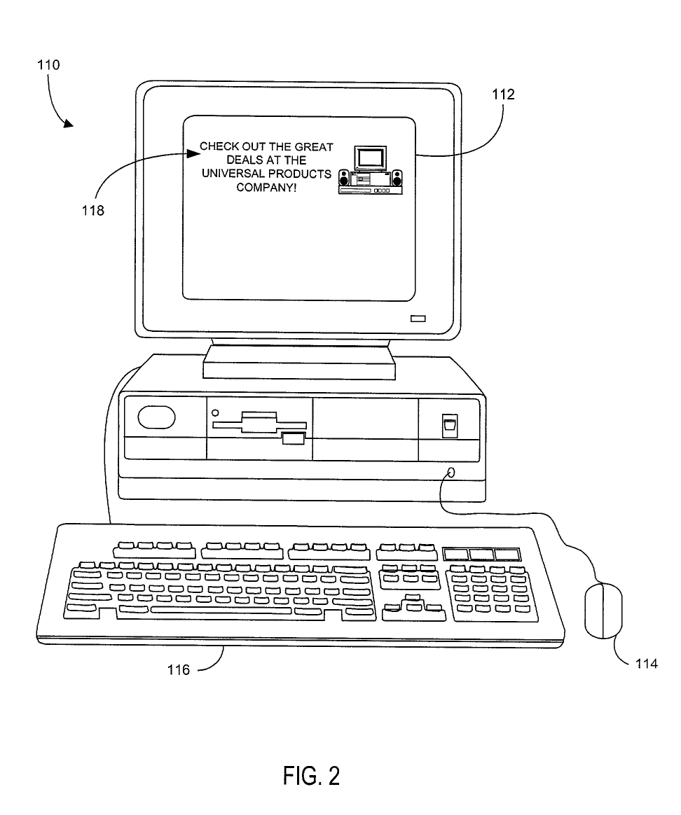

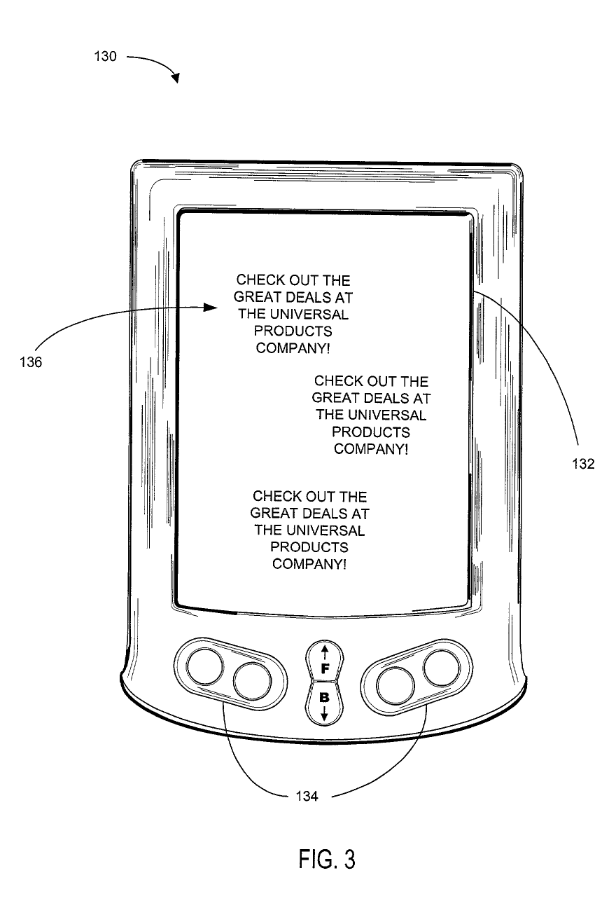

Now referring to FIG. 2, a computer system 110 is illustrated that includes a conventional screen or display 112, mouse 114, and keyboard 116. In accordance with the methods disclosed herein, an advertisement 118 consisting of a text portion and an image is displayed by the computer 110 on the screen 112. As the methods disclosed herein also may be used with other types of devices, a similar advertisement displayed on a personal digital assistant 130 is illustrated in FIG. 3. The personal digital assistant 130 includes a conventional screen 132 and buttons 134. The advertisement 136 displayed is displayed by the personal digital assistant on the screen 132.

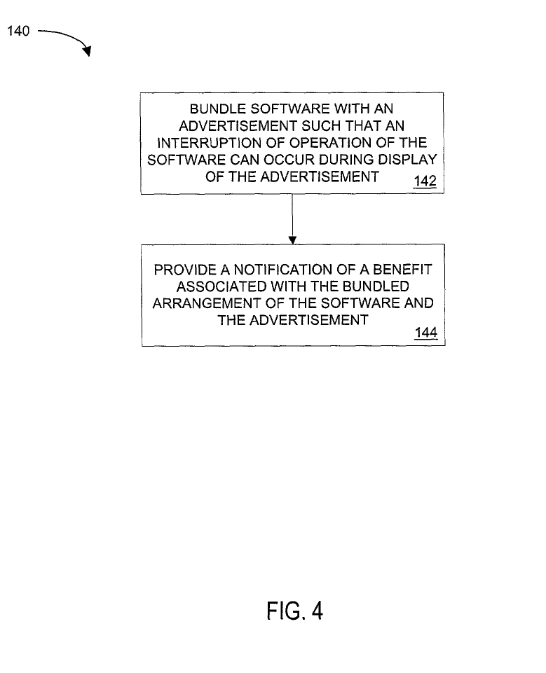

Reference is now made to FIG. 4, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below.

Processing begins at a step 142 during which a portion of software is integrated or otherwise bundled with or to one or more advertisements such that one or more advertisements may be displayed by a device when the portion of software is operating on the device and/or such that operation of the software may be interrupted during at least part of a display of an advertisement by the device. Thus, a relationship between the portion of software and the advertisement is created as previously discussed above.

During a step 144, a notification is provided regarding a benefit associated with the bundled arrangement of the portion of software and the advertisement. The benefit may be any of the benefits previously discussed above and may be determined as previously discussed above.

The notification provided during the step 144 may be in any format or form, including, but not limited to, HTTP, HTML or FTP transmission, XML feed, email message, instant message communication, facsimile or radio transmission, telephone call, electronic signal or communication, etc. The notification may be sent to a server, user device or other device. For example, the notification may be sent to a user using the portion of software and viewing the advertisement, to a supplier of the portion of software, advertisement, and/or benefit, to a company tracking displays of advertisements, etc.

In some embodiments, the method 144 may include determining the benefit, providing a bundled arrangement of the advertisement and the portion of software, providing a notification regarding the bundled arrangement of the advertisement and the portion of software to a device, user, supplier, etc. or other variations as previously discussed above.

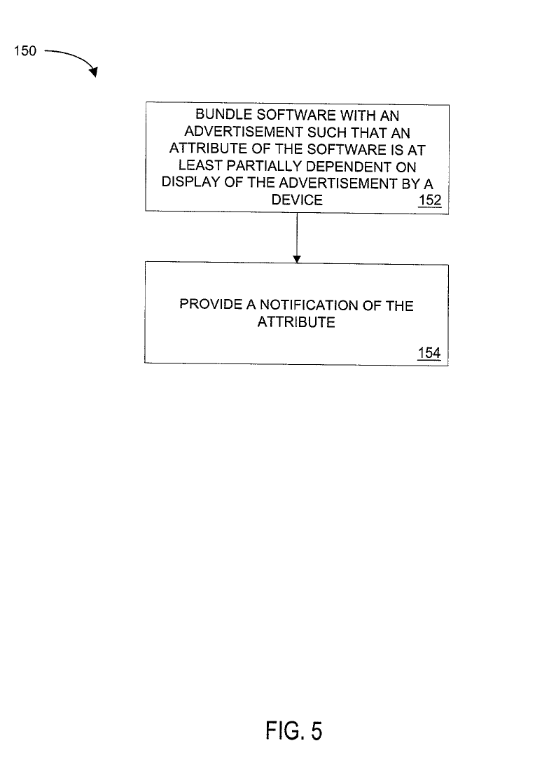

Reference is now made to FIG. 5, where a flow chart 150 is shown which represents the operation of a third embodiment of the present invention. The particular arrangement of elements in the flow chart 150 is not meant to imply a fixed order to the steps; embodiments of the present invention can be practiced in any order that is practicable. In some embodiments, some or all of the steps of the method 150 may be performed or completed by a server, user device and/or another device, as will be discussed in more detail below.

Processing begins at a step 152 during which a portion of software is bundled with an advertisement such that an attribute of the software is at least partially dependent on display of the advertisement on a device. In some embodiments, the advertisement may be displayed on the device while the portion of software is operating on the device. An attribute of the software may be or include many things such as, for example, speed of operation of the portion of software; availability of a feature provided by the portion of software; ability of the portion of software to display content on a visual display; ability of the portion of software to transmit, store and/or receive data; speed of operation of a device on which the portion of software is operating; ability of a device on which the portion of software is operating to display content on a visual or audio display; ability of a device on which the portion of software is operating to transmit, store, use, retrieve and/or receive data; etc.

As an example, the speed at which a software program saves, prints, calculates, displays or retrieves files or data may be related to the number of times an advertisement is displayed by a device on which the software is operating. As another example, the ability of a user to access or use features of a software program operating on a device may be dependent on how many times one or more advertisement have been displayed by the device or how long one or more advertisements have been displayed by the device.

An increase in the number or length of displays of one or more advertisements on a device, or an increase in the rate of display of one or more advertisements, may result in an increase in speed of operation of the portion of software or a device; an increase in availability of a feature provided by the portion of software; an increase in ability of the portion of software or a device to display content on a visual display; an increase in ability of the portion of software or a device to transmit, store, retrieve, use or receive data; etc.

During a step 154, a notification is provided regarding the attribute. The notification provided during the step 154 may be in any format or form, including, but not limited to, HTTP, HTML or FTP transmission, XML feed, email message, instant message communication, facsimile or radio transmission, telephone call, electronic signal or communication, etc. The notification may be sent to a server, user device or other device. For example, the notification may be sent to a user using the portion of software and viewing the advertisement, to a supplier of the portion of software, advertisement, and/or benefit, to a company tracking or monitoring displays of advertisements, etc.

In some embodiments, the method 150 may include determining the benefit, providing a bundled arrangement of the advertisement and the portion of software, providing a notification regarding the bundled arrangement of the advertisement and the portion of software to a device, user, supplier, etc. or other variations as previously discussed above. In some embodiments, the method 150 also may include variations as previously discussed above.

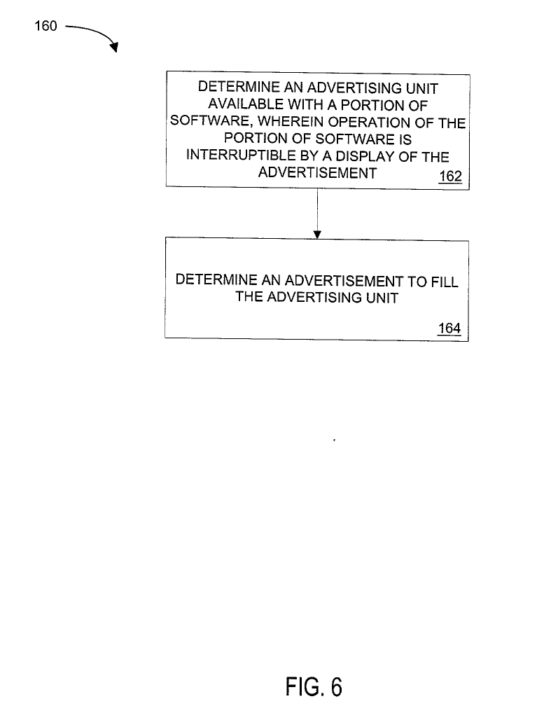

Reference is now made to FIG. 6, where a flow chart 160 is shown which represents the operation of a fourth embodiment of the present invention. The particular arrangement of elements in the flow chart 160 is not meant to imply a fixed order to the steps; embodiments of the present invention can be practiced in any order that is practicable. In some embodiments, some or all of the steps of the method 160 may be performed or completed by a server, user device and/or another device, as will be discussed in more detail below. The method 160 has particular use for an advertiser that wants to incorporate advertisements into software provided by the advertiser or another party. In a manner similar to print, online or other media advertising, the advertiser determines where an advertisement can be placed and distributed.

Processing begins at a step 162 during which one or more advertising units or other advertising spaces available with a portion of software is determined, wherein display of the advertisement on a device can interrupt operation of the portion of software as previously discussed above. For example, a company distributing a low-cost software product may incorporate or bundle one or more advertisements (or links to the advertisements) into the software product by creating one or more advertising units with the software. Each advertising unit for a portion of software may need an associated advertisement (or link to an advertisement) that will be displayed by a device during operation of the portion of software on the device.

An available advertising unit may be advertised by a software developer or distributor. In some embodiments, a supplier of an advertisement may have an exclusive arrangement for one or more advertising units. In other embodiments, advertising units may be sold or made available on a first-come first-serve basis. Thus, the advertising units for the software become another outlet for advertisements and the placement of advertisements by advertisers.

By selling the advertising spaces in the portion of software, a software developer or supplier may offset the cost of developing or distributing the software and make the software more inexpensive to consumers or users. An advertisement may be used with more than one advertising unit. Compensation or benefit for including the advertisement in an advertising unit may be provided by the advertiser or the advertiser's client.

During a step 164, an advertisement is determined to fill the advertising unit. The step 164 may be completed by receiving an advertisement or a link to an advertisement, receiving an order for placement of a particular advertisement, selecting an advertisement from among a group of potential advertisements, etc. In some embodiments, an advertisement may be selected based, at least in part, on the type or nature of the portion of software, the type or nature of a device on which the advertisement will be displayed, a characteristic or attribute of a user or potential user of the software or viewer or potential viewer of the advertisement, etc.

In some embodiments, the method 160 may include providing the portion of software and or the advertisement, bundling the portion of software and the advertisement, providing a notification regarding the portion of software and the advertisement, determining a benefit associate with the software and/or the advertisement, or other variations as previously discussed above.

In addition to the methods discussed above, other embodiments of the method of the present invention are also possible. For example, a method for facilitating display of an advertisement with a portion of executable software may include determining a plurality of advertising units available with a portion of executable software, wherein operation of the portion of executable software is interruptible by a display of an advertisement; determining an first advertisement to fill a first of the plurality of advertising units and a second advertisement to fill a second of the plurality of advertising units; and bundling the portion of executable software, the first advertisement and the second advertisement.

In other embodiments of the method of the present invention, a method for providing compensation for display of an advertisement associated with a portion of software may include identifying a bundling of a portion of software and an advertisement such that the advertisement may be displayed by a device when the portion of software is operated with the device; determining a benefit associated with at least one display of the advertisement; and providing a notification of the benefit. An interruption of use of the portion of software may occur during at least a portion of at least one display of the advertisement. The benefit may be based, at least in part, on a price associated with the portion of software or any of the other factors previously discussed above.

In other embodiments of the method of the present invention, a method for using an advertisement with a portion of software may include receiving a portion of software; receiving an advertisement, the advertisement being associated with the software such that operation of the portion of executable software on a device can be interrupted during at least a portion of at least one display of the advertisement by the device; and operating the portion of software.

In other embodiments of an apparatus of the present invention, a software program may include a portion of executable software and at least one advertisement, wherein operation of the portion of executable software on a device can be interrupted during at least a portion of at least one display of the at least one advertisement by the device. Alternatively, a software program may include a portion of executable software and at least on advertisement, wherein performance of the portion of executable software on a device can be altered as a result of at least one display of the at least one advertisement by the device.

System

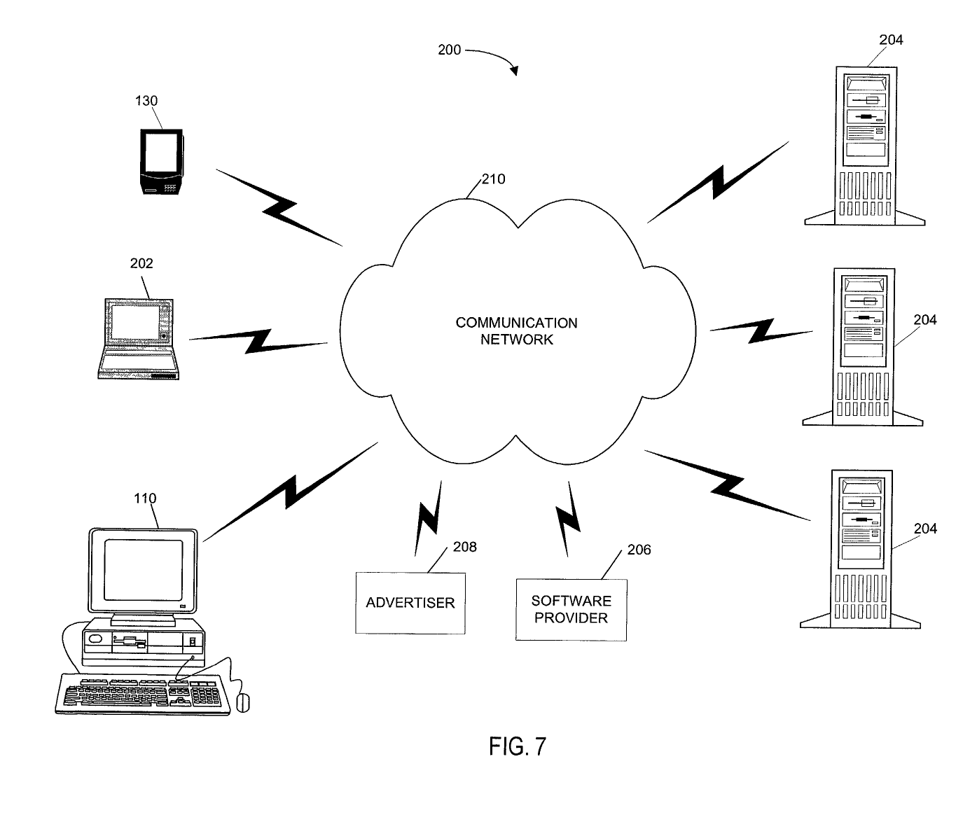

Now referring to FIG. 7, an apparatus or system 200 usable with the methods disclosed herein is illustrated. The apparatus 200 includes one or more user or client devices 202 that may communicate directly or indirectly with one or more servers, controllers or other devices 204 via a computer, data, or communications network 210. The system 200 also may include a device 206 associated with a software supplier or provider that may be used to send and receive advertisements, software products, interfaces, portions of software, information regarding advertisers or advertisements, information regarding available advertising units, etc. The device 206 may be a server, a user device or some other kind of device. The system 200 also may include a device associated with an advertiser (e.g., a computer or server) 208 that an advertiser may use to send and receive advertisements, information regarding software products, advertising units, etc. The device 208 may be a server, a user device or some other kind of device.

A server 204 may implement or host a Web site. A server 204 can comprise a single device or computer, a networked set or group of devices or computers, a workstation, etc. In some embodiments, a server 204 also may function as a database server and/or as a user device. A server 204 may implement any of the methods disclosed herein. A server 204 also may provide and/or receive software and/or advertisements from one or more other devices. The use, configuration and operation of servers will be discussed in more detail below.

The user or client devices 202 preferably allow users to interact with the server 204 and the remainder of the apparatus 200, receive or provide advertisements, content, notifications, software, etc. The user devices 202 also may enable a user to access Web sites, software, databases, etc. hosted or operated by the servers 204 or other devices. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc. The computer 110 of FIG. 2 and the personal digital assistant 130 of FIG. 3 also may be user devices.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 7 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 7 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204.

Although a limited number of devices are shown in FIG. 7, any number of such devices may be included in the system 200. The devices shown in FIG. 7 need not be in constant communication. For example, a user device may communicate with a server only when such communication is appropriate or necessary.

Server

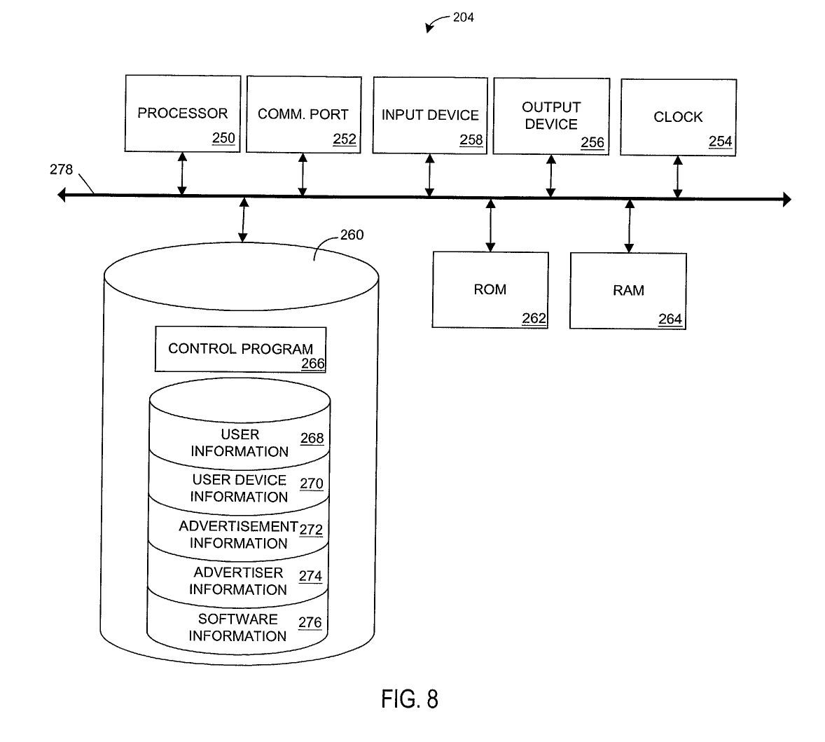

Now referring to FIG. 8, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications, advertisements, notifications, software, etc. received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, device drivers, advertisements, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, communications, advertisements, advertisers, software, devices, etc. For example, information regarding one or more users may be stored in a user information database 268 for use by the server 204 or another device or entity. Information regarding one or more user devices may be stored in a user device database 270 for use by the server 204 or another device or entity. Information regarding one or more advertisements may be stored in an advertisement information database 272 for use by the server 204 or another device or entity. Information regarding one or more advertisers may be stored in an advertiser information database 274 for use by the server 204 or another device or entity. Information regarding one or more portions of software may be stored in a software information database 276 for use by the server 204 or another device or entity. In some embodiments, the databases may be stored remotely from the server 204.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 278.

While specific implementations and hardware configurations for servers 204 have been illustrated, it should be noted that other implementations and hardware configurations are possible and that no specific implementation or hardware configuration is needed. Thus, not all of the components illustrated in FIG. 7 may be needed for a server or other device implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, television, personal digital assistant, facsimile machine, two-way pager, radio, cable set-top box, etc. If desired, the user device 202 also may function as a server 204, as an advertisement server, advertiser device and/or software provider device. In some embodiments, a user device 202 may have the same structure or configuration as the server 204 illustrated in FIG. 8 and include some or all of the components of the server 204.

Databases

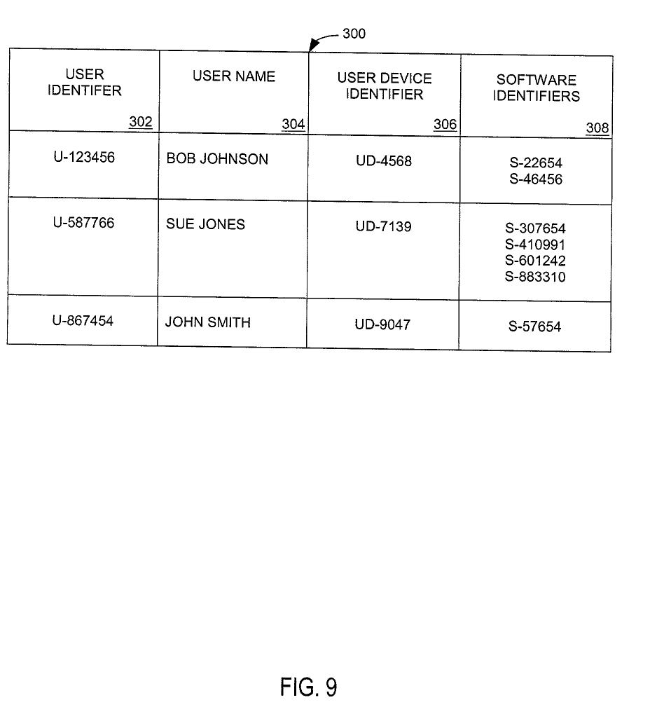

As previously discussed above, in some embodiments a server, user device, or other device may include or access a user information database for storing or keeping information regarding people purchasing software, people who have received software and/or advertisements, etc. One representative user information database 300 is illustrated in FIG. 9.

The user information database 300 may include a user identifier field 302 that may include codes or other identifiers for one or more users, a user name field 304 that may includes names, descriptions, contact information, personal information, etc. for the users identified in the field 302, a user device identifier field 306 that may include codes or other identifiers for user devices associated with the users identified in the field 306, and a software identifier field 308 that may include codes or other identifiers for software products, programs, etc. that that are used, controlled or operated by the users identified in the field 302 or otherwise associated with the users identified in the field 302 or the user devices identified in the field 306. Other or different fields also may be used in the user information database 300. A user may be associated with one or more user devices and/or one or more software programs, and vice versa.

As illustrated by the user information database 300 of FIG. 9, the user identified as “U-123456” in the field 302 is named “BOB JOHNSON” and is associated with the user device identified as “UD-4568” and the software identified as “S-22654” and “S46456”. The user identified as “U-123456” may own or use the user device “UD-4568.” The software programs identified as “S-22654” and “S-46456” may be stored on the user device “UD-4568” or operated with the user device “UD-4568.” Information regarding the user device “US-4568” may be found in a user device information database while information regarding the software programs “S-22654” and/or “S-46456” may be found in a software information database.

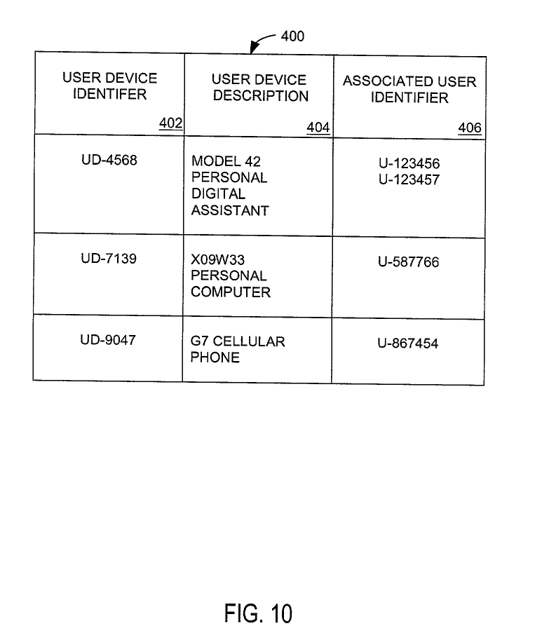

As previously discussed above, in some embodiments a server, user device, or other device may include or access a user device information database for storing or keeping information regarding one or more user devices. One representative user device information database 400 is illustrated in FIG. 10.

The user device information database 400 may include a user device identifier field 402 that may include codes or other identifiers for one or more user devices, a user device description field 404 that may include names, descriptions, operating or performance specifications, etc. for the user devices identified in the field 402, and an associated user identifier field 406 that may include codes or other identifiers for one or more users associated with the user devices identified in the field 402. Other or different fields also may be used in the user device information database 400. As illustrated by the user device information database 400 of FIG. 10, the user device identified as “UD4568” in the field 402 is a “MODEL 42 PERSONAL DIGITAL ASSISTANT” as is used by or otherwise associated with the two users identified as “U-123456” and “U-123457.”

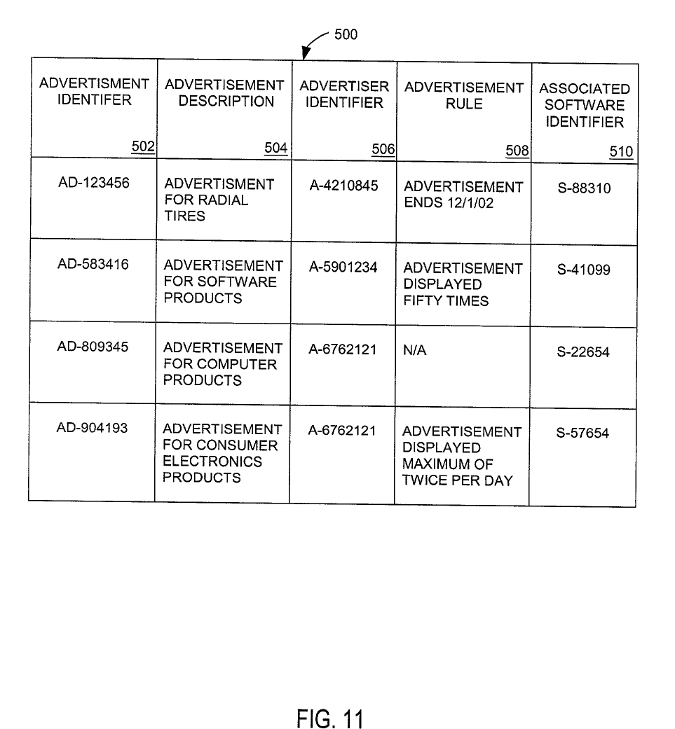

As previously discussed above, in some embodiments a server, user device, or other device may include or access an advertisement information database for storing or keeping information regarding advertisements or other content that may be associated with software, provided with software, etc. One representative advertisement information database 500 is illustrated in FIG. 11.

The advertisement information database 500 may include an advertisement identifier field 502 that may include codes or other identifiers for one or more advertisements, an advertisement description field 504 that may include descriptive, operational or other information for the advertisements identified in the field 502, an advertiser identifier field 506 that may include codes or other identifiers for advertisers, if any, associated with the advertisements identified in the field 502, an advertisement rule field 508 that may include rules or other conditions associated with the advertisements identified in the field 502, and an associated software identifier field 510 that may include codes or other identifiers for software products, programs, etc. associated with the advertisements identified in the field 502. Other or different fields also may be used in the advertisement information database 500.

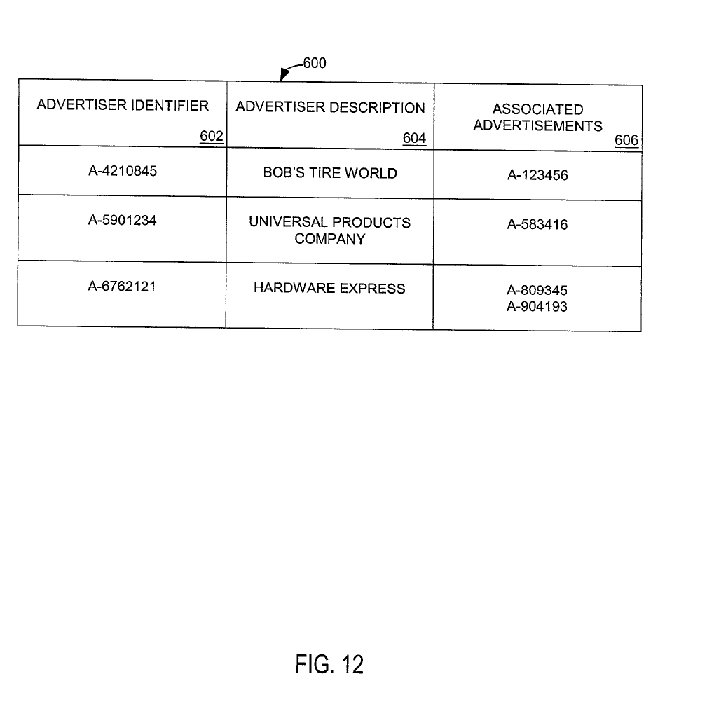

As illustrated by the advertisement information database 500 of FIG. 11, the advertisement identified as “AD-123456” in the field 502 is an “ADVERTISEMENT FOR RADIAL TIRES” and is sponsored or provided by the advertiser identified as “A4210845”. The advertisement identified as “AD-123456” should end on Dec. 1, 2002, and is associated with the software identified as “S-88310”. The advertisement identified as “AD-583416” is an “ADVERTISEMENT FOR SOFTWARE PRODUCTS” sponsored by the advertiser identified as “A-5901234” and is to be displayed a maximum of fifty times in conjunction with the software program identified as “S-41099.” As previously discussed above, in some embodiments a server, user device, or other device may include or access an advertiser information database for storing or keeping information regarding one or more advertisers, advertising agencies, etc. One representative advertiser information database 600 is illustrated in FIG. 12.

The advertiser information database 600 may include an advertisement identifier field 602 that may include codes or other identifiers for one or more advertisements, an advertiser description field 602 that may include a name, contract information, address, description or other information regarding the advertisers identified in the field 602, and an associated advertisements field 606 that may include codes or other identifiers for advertisements associated with the advertisers identified in the field 602. Other or different fields also may be used in the advertiser information database 600. As illustrated by the advertiser information database 600 of FIG. 12, the advertiser identified as “A-4210845” in the field 602 is named “BOB'S TIRE WORLD” and is associated with the advertisement “A-123456”.

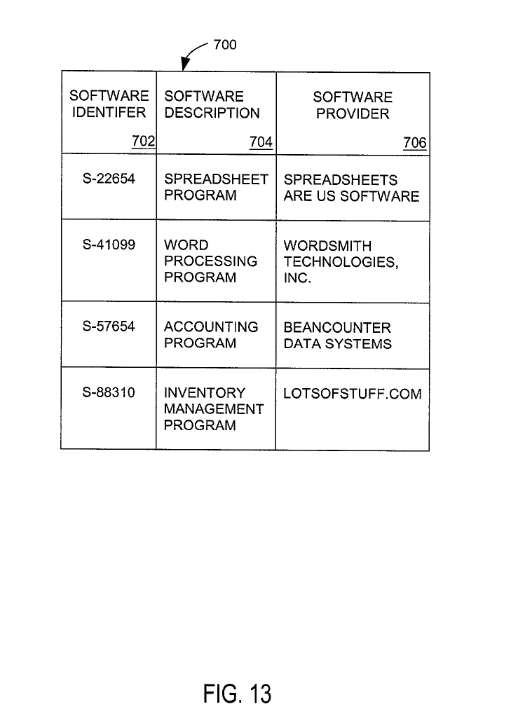

As previously discussed above, in some embodiments a server, user device, or other device may include or access a software information database for storing or keeping information regarding one or more software programs. One representative software information database 700 is illustrated in FIG. 13.

The software information database 700 may include a software identifier field 702 that may include codes or other identifiers for one or more software programs, a software description field 704 that may include a name, description, operational or technical details, or other information for the software identified in the field 702, and a software provider field 706 that may include names, codes, or other identifiers for one or more suppliers, manufacturers, sellers, etc. of the software identified in the field 702. Other or different fields also may be used in the software information database 700. As illustrated by the software information database 700 of FIG. 13, the software identified as “S-22654” in the field 702 is a “SPREADSHEET PROGRAM” and is provided by “SPREADSHEETS ARE US SOFTWARE.”

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating display of an advertisement with a portion of software, comprising:
determining a portion of software;
determining an advertisement; and
establishing a relationship between said portion of software and said advertisement such that an interruption of use of said portion of software on a device can occur, said interruption of use associated with at least one display of said advertisement by said device.

2. The method of claim 1, wherein said determining a portion of software includes at least one of the following:
receiving said portion of software;
retrieving said portion of software;
selecting said portion of software from a plurality of portions of software; and
receiving data indicative of a location of said portion of software.

3. The method of claim 1, wherein said determining an advertisement includes at least one of the following:
receiving said advertisement;
retrieving said advertisement;
selecting said advertisement from a plurality of advertisements; and
receiving data indicative of a location of said advertisement.

4. The method of claim 1, wherein said establishing a relationship between said portion of software and said advertisement such that said advertisement may be displayed by a device when said portion of software is operated with said device includes at least one of the following:
allowing said advertisement to be displayed by said device when said portion of software is operated with said device;
suspending operation of said portion of software while said advertisement is displayed by said device;
providing a notification of said relationship between said portion of software and said advertisement;
storing said advertisement and said portion of software on a computer readable medium;
providing said portion of software and said advertisement to said device;
providing said portion of software and a link to said advertisement;
determining when said advertisement will be displayed by said device;
determining a length of time said advertisement will be displayed by said device;
determining under what circumstances said advertisement will be displayed by said device;
determining when said advertisement will be displayed to a user;
determining a length of time said advertisement will be displayed to a user; and
determining under what circumstances said advertisement will be displayed to a user.

5. The method of claim 1, further comprising:
determining a benefit available for display of said advertisement by said device.

6. The method of claim 5, wherein said determining a benefit available for display of said advertisement includes at least one of the following:
receiving a notification of said benefit;
allowing a user to select from a plurality of benefits;
offering a plurality of benefits to a user and receiving a notification from said user of a selection of at least one of said plurality of benefits;
receiving a request from a user for said benefit; and
selecting said benefit from a plurality of benefits.

7. The method of claim 5, further comprising:
providing a notification of said benefit.

8. The method of claim 7, wherein said providing a notification of said benefit includes at least one of the following:
providing said notification to a user;
providing said notification to said device;
sending an electronic communication to an address associated with a user;
sending an electronic communication to an address associated with said device;
sending an electronic communication to a provider of said benefit;
sending an electronic communication to a provider of said advertisement; and
sending an electronic communication to a provider of said portion of software.

9. The method of claim 5, wherein said benefit includes at least one of the following:
an improvement in performance of said portion of software;
an availability of a feature provided by said portion of software;
a rebate for a previous purchase of said portion of software;
a discount for a future purchase of said portion of software;
a credit;
a coupon; and
frequent flyer miles.

10. The method of claim 5, wherein said benefit is based on at least one of the following:
feedback from a user regarding said advertisement;
feedback from a user regarding said portion of software;
a number of updates to said advertisement requested by a user;
a number of updates to said advertisement provided to said device;
a demographic characteristic of a user;
a usage pattern of said device;
a usage pattern of said portion of software;
a number of advertisements displayed by said device during a time period;
an action taken by said user in response to said advertisement;
a monetary amount associated with said advertisement;
a rate associated with said advertisement;
a status associated with a user;
a social index associated with a user;
a price associated with said portion of software;
a number of displays of said advertisement on said device;
a length of time said advertisement is displayed by said device;
a number of times said portion of software is operated with said device; and
a length of time said portion of software is operated with said device.

11. The method of claim 1, further comprising:
providing said portion of software.

12. The method of claim 11, wherein said providing said portion of software includes at least one of the following:
providing said portion of software to a user device;
providing said portion of software to a server;
serving said portion of software;
downloading said portion of software;
including said portion of software in an electronic communication;
providing an electronic address where said portion of software can be found;
providing an electronic address from where said portion of software can be requested; and
providing an electronic address from where said portion of software can be retrieved.

13. The method of claim 1, further comprising:
providing said advertisement.

14. The method of claim 13, wherein said providing said advertisement to a device includes at least one of the following:
providing said advertisement to a user device;
providing said advertisement to a server;
providing said advertisement to a device on which said portion of software is stored;
providing said advertisement to a device on which said portion of software is used;
serving said advertisement;
downloading said advertisement;
including said advertisement in an electronic communication;
providing an electronic address where said advertisement can be found;
providing an electronic address from where said advertisement can be requested; and
providing an electronic address from where said advertisement can be retrieved.

15. The method of claim 1, wherein said advertisement includes at least one of the following:
an image;
software code;
an electronic signal;
a sound file;
a multimedia file;
rich media;
a video clip;
audio material;
text material; and
an animation.

16. The method of claim 1, wherein said establishing a relationship between said portion of software and said advertisement such that said advertisement may be displayed by a device when said portion of software is operated with said device includes inserting said advertisement into said portion of software.

17. The method of claim 1, wherein said establishing a relationship between said portion of software and said advertisement such that said advertisement may be displayed by a device when said portion of software is operated with said device includes inserting a link to said advertisement into said portion of software.

18. The method of claim 1, wherein said establishing a relationship between said portion of software and said advertisement such that said advertisement may be displayed by a device when said portion of software is operated with said device includes providing said advertisement with said portion of software.

19. The method of claim 1, further comprising:
updating said advertisement.

20. The method of claim 1, further comprising:
determining a number of displays of said advertisement on said device.

21. The method of claim 1, further comprising:
determining a length of time said advertisement is displayed by said device.

22. The method of claim 1, further comprising:
receiving feedback from a user regarding said advertisement.

23. The method of claim 1, wherein multiple distinct advertisements may be associated with said portion of software.

24. The method of claim 1, wherein said advertisement may be associated with multiple distinct portions of software.

25. The method of claim 1, further comprising:
providing a notification of said relationship between said portion of software and said advertisement.

26. The method of claim 1, wherein said device will cease displaying said advertisement after said device has displayed said advertisement a predetermined number of times.

27. The method of claim 1, wherein said device will cease displaying said advertisement during a time period after said device has displayed said advertisement a predetermined number of times during said time period.

28. The method of claim 1, wherein said interruption of use of said portion of software includes at least one of the following:
a delay in visual display of data by said portion of software;
a delay in transmission of data by said device;
a delay in storage of data by said device;
a delay in reception of data by said device;
a delay in transmission of data by said portion of software;
a delay in storage of data by said portion of software;
a delay in reception of data by said portion of software;
a delay in operation of said portion of software while said advertisement is displayed by said device;
an interruption in display of material by said device;
an interruption in display of material by said portion of software;
a delay in use of data by said portion of software;
a delay in use of data by said device;
a delay in manipulation of data by said portion of software;
a delay in manipulation of data by said device;
a display of a window by said device;
a display of an image by said device;
a change in display of material by said device from foreground to background;
a change in display of material by said device from background to foreground;
a change in display of material by said portion of software from foreground to background;
a change in display of material by said portion of software from background to foreground;
a prevention of use of at least one feature of said portion of software while said advertisement is displayed by said device; and
a suspension of usability of said portion of software while said advertisement is displayed by said device.

29. The method of claim 1, wherein said software is executable software.

30. A method for facilitating display of an advertisement with a portion of software, comprising:
bundling a portion of software and an advertisement such that an interruption of use of said portion of software may occur during at least a portion of at least one display of said advertisement; and
providing a notification of a benefit associated with said bundled arrangement of said portion of software and said advertisement.

31. The method of claim 30, further comprising:
determining said benefit.

32. The method of claim 30, further comprising:
providing a notification of said benefit to said user.

33. The method of claim 30, further comprising:
providing a bundled arrangement of said portion of software and said advertisement to a device.

34. The method of claim 30, wherein said providing a notification of a benefit includes providing said portion of software.

35. The method of claim 30, wherein said providing a notification of a benefit includes providing a bundled arrangement of said portion of software and said advertisement.

36. The method of claim 30, wherein said advertisement may be displayed by a device when said portion of software is operated with said device.

37. A method for facilitating display of an advertisement with a portion of software, comprising:
determining a first advertising unit available with a portion of executable software, wherein operation of said portion of software is interruptible by a display of an advertisement; and
determining a first advertisement to fill said first advertising unit.

38. The method of claim 37, further comprising:
receiving compensation for said providing said portion of executable software and said advertisement.

39. The method of claim 37, further comprising:
determining a second advertisement to fill a second advertising unit available with said portion of executable software.

40. The method of claim 37, further comprising:
providing said portion of executable software and said first advertisement.

41. The method of claim 37, further comprising:
providing a notification regarding said portion of executable software and said first advertisement.

42. The method of claim 37, further comprising:
bundling said first advertisement and said portion of executable software.

43. A method for facilitating display of an advertisement with a portion of executable software, comprising:
determining a plurality of advertising units available with a portion of executable software, wherein operation of said portion of executable software is interruptible by a display of an advertisement;
determining an first advertisement to fill a first of said plurality of advertising units and a second advertisement to fill a second of said plurality of advertising units; and bundling said portion of executable software, said first advertisement and said second advertisement.

44. A method for facilitating display of an advertisement with a portion of executable software, comprising:
bundling a portion of software and at least one advertisement such that an attribute of said portion of software is at least partially dependent on display of said at least one advertisement on a device; and
providing a notification of said attribute.

45. The method of claim 44, further comprising:
providing said advertisement and said portion of software.

46. The method of claim 44, wherein said attribute includes at least one of the following:
speed of operation of said portion of software;
availability of a feature provided by said portion of software;
ability of said portion of software to display content on a visual display;
ability of said portion of software to transmit data;
ability of said portion of software to store data;
ability of said portion of software to receive data;
speed of operation of a device on which said portion of software is operating;
ability of a device on which said portion of software is operating to display content on a visual display;
ability of a device on which said portion of software is operating to transmit data;
ability of a device on which said portion of software is operating to store data; and
ability of a device on which said portion of software is operating to receive data.

47. The method of claim 44, wherein said attribute of said portion of software is at least partially dependent on said display of said at least one advertisement on said device such that an increase in a number of times said at least one advertisement is displayed on said device results in at least one of the following:
an increase in speed of operation of said portion of software;
an increase in availability of a feature provided by said portion of software;
an increase in ability of said portion of software to display content on a visual display;
an increase in ability of said portion of software to transmit data;
an increase in ability of said portion of software to store data;
an increase in ability of said portion of software to receive data;
an increase in speed of operation of a device on which said portion of software is operating;
an increase in ability of a device on which said portion of software is operating to display content on a visual display;
an increase in ability of a device on which said portion of software is operating to transmit data;
an increase in ability of a device on which said portion of software is operating to store data; and
an increase in ability of a device on which said portion of software is operating to receive data.

48. The method of claim 44, wherein said attribute of said portion of software is at least partially dependent on said display of said at least one advertisement on said device such that an increase in a rate of display of said at least one advertisement said device results in at least one of the following:
an increase in speed of operation of said portion of software;
an increase in availability of a feature provided by said portion of software;
an increase in ability of said portion of software to display content on a visual display;
an increase in ability of said portion of software to transmit data;
an increase in ability of said portion of software to store data;
an increase in ability of said portion of software to receive data;
an increase in speed of operation of a device on which said portion of software is operating;
an increase in ability of a device on which said portion of software is operating to display content on a visual display;
an increase in ability of a device on which said portion of software is operating to transmit data;
an increase in ability of a device on which said portion of software is operating to store data; and
an increase in ability of a device on which said portion of software is operating to receive data.

49. The method of claim 44, wherein said at least one advertisement may be displayed by a device when said portion of software is operated with said device.

50. A method for providing a benefit for display of an advertisement associated with a portion of software, comprising:
identifying a bundling of a portion of software and an advertisement such that said advertisement may be displayed by a device when said portion of software is operated with said device;
determining a benefit associated with at least one display of said advertisement; and
providing a notification of said benefit.

51. The method of claim 50, wherein an interruption of use of said portion of software may occur during at least a portion of at least one display of said advertisement.

52. The method of claim 50, wherein said benefit is based, at least in part, on a price associated with said portion of software.

53. A method for using an advertisement with a portion of software, comprising:
receiving a portion of software;
receiving an advertisement, said advertisement being associated with said software such that operation of said portion of executable software on a device can be interrupted during at least a portion of at least one display of said advertisement by said device; and
operating said portion of software.

54. A software program, comprising a portion of executable software and at least one advertisement, wherein operation of said portion of executable software on a device can be interrupted during at least a portion of at least one display of said at least one advertisement by said device.

55. A software program, comprising a portion of executable software and at least on advertisement, wherein performance of said portion of executable software on a device can be altered as a result of at least one display of said at least one advertisement by said device.

56. A system for facilitating display of an advertisement, comprising:
a memory;
a communication port; and
a processor connected to said memory and said communication port, said processor being operative to:
determine a portion of software;
determine an advertisement; and
establish a relationship between said portion of software and said advertisement such that an interruption of use of said portion of software on a device can occur, said interruption of use associated with at least one display of said advertisement by said device.

57. A computer program product in a computer readable medium for facilitating display of an advertisement, comprising:
first instructions for identifying a portion of software;
second instructions for identifying an advertisement; and
third instructions for causing an interruption of use of said portion of software on a device, said interruption of use associated with at least one display of said advertisement by said device.
